(19) United States
(12) Patent Application Publication
(10) Pub. No.: US 2021/0078774 A1
(43) Pub. Date: Mar. 18, 2021

(54) Device And Method For Dispensing Pourable Materials From Packages

(71) Applicant: Avner Kitai, Kadima (IL)

(72) Inventor: Avner Kitai, Kadima (IL)

(21) Appl. No.: 16/574,145

(22) Filed: Sep. 18, 2019

(51) Int. Cl. B65D 47/08; B67D 3/00; B65D 51/30; B65D 75/70; B65D 75/58

(52) U.S. Cl. CPC B65D 47/0838; B67D 3/0061; B65D 75/5872; B65D 75/70; B65D 51/30

(57) ABSTRACT

A system and method for dispensing a package of pourable contents including: a dispensing apparatus including: (a) a shaft part having a mouth at a distal end thereof; (b) a flange part extending radially around an aperture at a proximal end of the shaft part; and (c) a cutting mechanism nestled in the shaft part, the cutting mechanism having a retracted state and an extended state; wherein the dispensing apparatus is adapted for use with one or more packages.

### FIELD OF THE INVENTION

The present invention relates to a means and associated method for dispensing pourable materials from a package and, more particularly, to a reusable dispensing apparatus that couples with a single-use adhering portion/attachment piece for attaching to packages of pourable materials.

### BACKGROUND OF THE INVENTION

The problems associated with the dispensing of pourable materials from their packaging are well known. These include spillage which is commonly associated with the dispensing of pourable materials including various liquids, granulated or powdered materials for example, sugar, salt, cement, sand, vegetables, pills and the like. Spillage can result in financial loss due to wastage, in contamination of the environment, such as where the pourable material is of a hazardous nature or simply non-biodegradable, and, perhaps even more significantly, the generation of an undesirable mess.

Many packages are supplied with lips, spouts or other pouring aids attached to them to facilitate the controlled dispensing of the materials from there within. Such packages are typically manufactured with integral dispensing spouts. Nevertheless many consumerables are supplied in a package lacking any means for facilitating the dispensing of contents from within. A common example of such a package is a heat sealed plastic bag which is typically opened by cutting or by pulling the seam open. Such bags usually lack a method of resealing after use. Apart from the risk of spillage, poor sealing may result in deterioration of the consumerable which is no longer isolated from the environment.

There is a need for a reusable means for dispensing pourable materials from packaging with a safe cutting tool and a simple method for employing said means.

### SUMMARY OF THE INVENTION

According to the present invention there is provided a dispensing system for a package of pourable contents, the system including: a dispensing apparatus including: (a) a shaft part having a mouth at a distal end thereof; (b) a flange part extending radially around an aperture at a proximal end of the shaft part; and (c) a cutting mechanism nestled in the shaft part, the cutting mechanism having a retracted state and an extended state; wherein the dispensing apparatus is adapted for use with one or more packages.

According to further features in preferred embodiments of the invention described below the dispensing system further includes: an attachment piece adapted to detachably couple to the flange part, the attachment piece having a proximal surface provided with an adhesive layer; wherein the attachment piece is adapted for use with a single package.

According to still further features in the described preferred embodiments the pourable contents are dispensable from the package in a controlled manner after forming an incision in a surface of the package under the aperture.

According to still further features in the retracted state, teeth of a cutting piece of the cutting mechanism are retraced into the aperture and in the extended state, the teeth protrude out of the aperture at the proximal end of the shaft part.

According to still further features the cutting mechanism includes: (i) a cutting piece comprising an annular ring, teeth protruding from a proximal edge of the ring and two arms that extend from opposite sides of an external surface of the ring; (ii) a guide-path for the arms, the guide-path structured to guide the cutting piece to protrude beyond, and retract back from, a bottom edge of the proximal aperture of the shaft part; and (iii) a grip piece for actuating the cutting mechanism by rotating the cutting piece about a central axis of the shaft part and moving the arms along the guide path.

According to still further features the guide-path allows for rotation of the cutting piece more than 90° and less than 180° about the central axis.

According to still further features the cutting piece is adapted to cut an incomplete circular incision in the package in such a manner that a circular flap of material of the package remains attached to the package. According to still further features the circular flap of material is raised towards the distal mouth.

According to still further features the dispensing system further includes a lid operationally coupled to the dispensing apparatus and adapted to close the mouth on the distal end. According to still further features the lid forms a water-tight or airtight seal with the dispensing apparatus in a closed state.

According to still further features the dispensing system further includes a stopper adapted to fit into or cover over the aperture, the stopper adapter for stoppering the aperture after detaching the dispensing apparatus. According to still further features the lid includes a compartment adapted to receive a desiccant bag or scented bag.

According to still further features the dispensing system further includes a filter and/or a portion control mechanism adapted to allow a predefined portion of the pourable contents to be dispensed and/or an adaptor for receiving a vacuum hose, adapted to fit in the distal mouth. According to still further features the system further includes a means for sealing the distal mouth prior to removing the vacuum hose.

According to still further features the dispensing system further includes a manual or automatic grinder operationally coupled to the dispensing apparatus, for grinding the pourable contents prior to dispensing.

According to still further features the lid has a counter disposed on an outer surface thereof or a human interface device (HID) disposed on an outer surface thereof, the HID adapted display output. According to still further features the HID is further adapted to receive input. According to still further features the HID is further adapted to send notifications and alerts to a remote computing device.

According to still further features the lid further includes at least one sensor disposed on an inner surface thereof, the at least one sensor is selected from the group of sensors adapted to sensor at least one of: an allergen, motion, weight, decomposition, insect pheromones, color.

According to still further features the dispensing apparatus is adapted to be twisted and rotated by a user. According to still further features the dispensing apparatus further includes a bar attachment for weak hands.

According to still further features the system further includes a connector with a first opening, a second opening and a body (tubular, conical etc.) there-between, the connector adapted to couple to the distal mouth or the attachment piece at the first opening.

According to another embodiment there is provided a dispensing system including: an attachment piece adapted to detachably couple to a dispensing apparatus, the attachment piece having a proximal surface provided with an adhesive layer; wherein the attachment piece is adapted for use with a single package. According to still further features the system further includes the dispensing apparatus including: (a) a shaft part having a mouth at a distal end thereof; (b) a flange part extending radially around an aperture at a proximal end of the shaft part; and (b) a cutting mechanism nestled in the shaft part, the cutting mechanism having a retracted state and an extended state; wherein the dispensing apparatus is adapted for use with one or more packages.

According to another embodiment there is provided a method of dispensing a pourable material from a package, the method including: (a) providing a dispensing apparatus, the dispensing apparatus adapted to dispense the pourable material from the package, the dispensing apparatus adapted for reuse with a plurality of packages; (b) providing an attachment piece adapted to detachably couple with the dispensing apparatus and permanently couple with the package; (c) mating the dispensing apparatus with the attachment piece; (d) adhering the attachment piece to a flat surface of the package so as to form an adhesive bond between the attachment piece and the package; (e) actuating a cutting mechanism of the dispensing apparatus to form an incomplete circular incision; (f) remove a circular flap of packaging material formed by the incomplete circular incision; (g) uncoupled the dispensing apparatus from the attachment piece; and (h) discard the package with the attachment piece adhered thereto.

According to still further features the method further includes peeling off, prior to step (d), a removable release liner from a lower surface of the attachment piece to expose an adhesive layer on the lower surface. According to still further features the method further includes attaching an accessory or connector to the dispensing apparatus

### BRIEF DESCRIPTION OF THE DRAWINGS

Various embodiments are herein described, by way of example only, with reference to the accompanying drawings, wherein:

FIG. 1 is an isometric view of an exemplary embodiment of dispensing system 10 according to the immediate invention;

FIG. 2 is an exploded view of the dispensing system 10;

FIG. 3 is a profile view of the side of the dispensing system 10;

FIG. 4 is a flow diagram of a method of assembly of the dispensing piece 100;

FIG. 5 is a flow diagram of a process of applying the instant dispensing system to packages;

FIG. 6 is a view of a stopper coupled to an attachment piece of the instant system;

FIGS. 7A, 7B and 7C are various configurations of connector pieces.

### DESCRIPTION OF THE PREFERRED EMBODIMENTS

The principles and operation of a re-usable dispensing apparatus with a single-use attaching piece according to the present invention may be better understood with reference to the drawings and the accompanying description.

There is disclosed herein a device and method for dispensing pourable materials from packages. The present invention is directed to a dispensing system for adhering to a package, forming an incision in the package and dispensing pourable contents from the package.

The instant system provides many advantages including, but not limited to: keeping the contents fresh for longer, easy dispensing, controlled dispensing, prevents moisture from entering (e.g. with watertight seals), prevents insect infestation, very user friendly and ergonomic, especially for the elderly, children, and the handicapped, all of whom often have weak hands or suffer from pain related to use of the hands. Using the instant dispensing system is preferred even over transferring the contents to reusable containers as the important information printed on the packaging is still available whereas one usually discards the original packaging when transferring the contents, thereby losing all the important information (dietary, allergenic etc.).

The dispensing system comprises a dispensing apparatus and an adhering portion/attachment piece. The dispensing apparatus comprises a shaft having a mouth at its distal end and a flange extending radially around an aperture at its proximal end. The dispensing apparatus includes a cutting mechanism that has a retracted state and an extended state. In the retracted state, teeth of the cutting mechanism are retracted into the aperture. In the extended state, the teeth protrude out of the aperture at the proximal end of the shaft.

The adhering portion/attachment piece is adapted to be detachably coupled to the dispensing apparatus by mating the upper side of the adhering portion/attachment piece to the flange in a locking arrangement. The adhering portion/attachment piece further has an adhesive layer upon its underside for attaching the adhering portion/attachment piece to an outer surface of a package. The dispensing device is adapted to form a circular incision in the package. A pourable material is dispensable from the package in a controlled manner through the aperture excised from the surface of the package encompassed by the flange and adhering/attachment piece. When the package is exhausted of pourable material, the dispensing apparatus is disconnected from the adhering/attachment piece for re-use. The adhering piece is discarded together with the empty package.

The dispensing system includes a resealable lid for covering and/or stoppering the distal mouth of the shaft. The resealable lid may be integrally coupled to the dispensing apparatus or it may be a separate piece such as a screw-on cap or a hung.

The term “bung” as used herein refers to any resealable lid adapted to fit inside the mouth of a spout. The term “lid” as used herein refers to any resealable cover adapted to fit over the distal mouth of the dispensing apparatus.

For a better understanding of the invention and to show how it may be carried into effect, reference will now be made, purely by way of example, to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

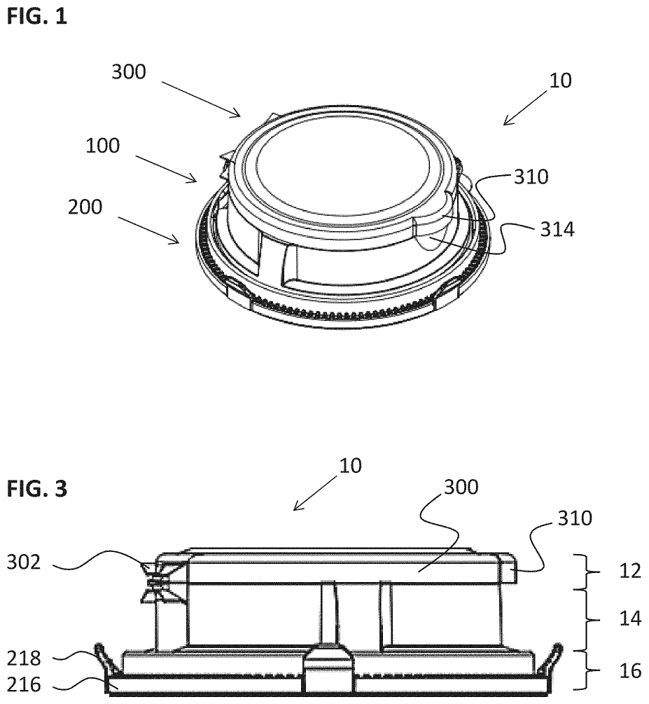

Referring now to the drawings, FIG. 1 illustrates an isometric view of an exemplary embodiment of a dispensing system 10 according to the immediate invention. Dispensing system 10 includes three general portions: a reusable dispensing apparatus 100, single-use adhering/attachment piece 200 and a covering piece or lid 300. In the instantly depicted and described embodiment, the lid 300 is integrally formed with the dispensing apparatus. This is not necessarily the case in other embodiments where the lid may be detachable and/or a separate element.

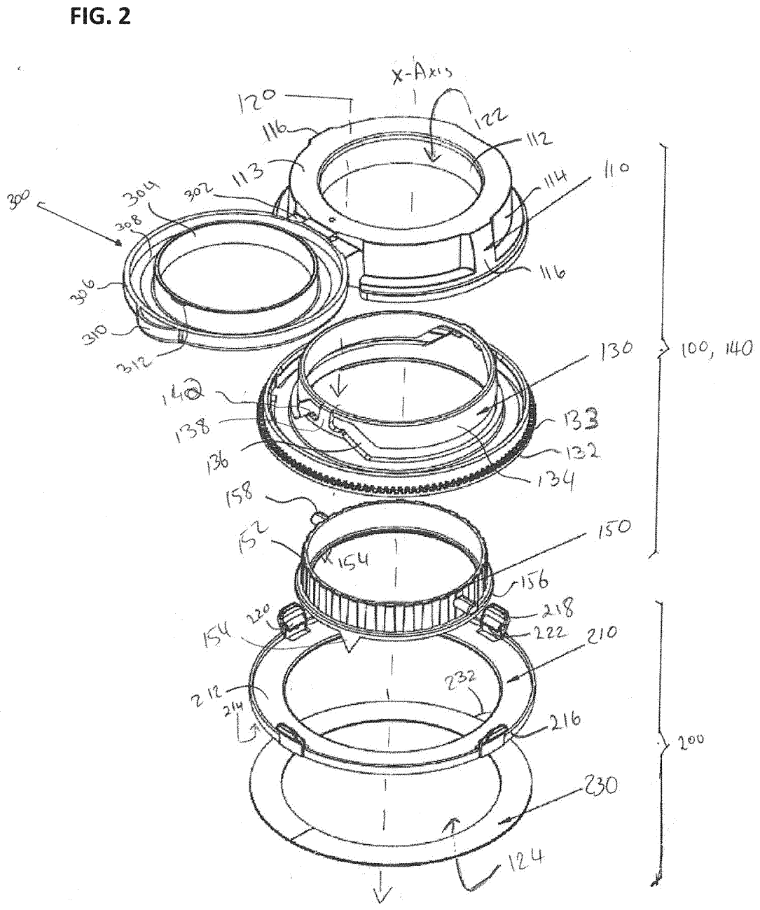

FIG. 2 illustrates an exploded view of the dispensing system 10. The dispensing system 10 includes three components that make up the dispensing apparatus and two components that make up the adhering attachment piece. The system further comprises a third part, namely a lid 300.

The dispensing apparatus 100 includes a grip piece 110, a guide piece 130 and a cutting piece 150. The cutting piece, guide piece and grip piece are nestled one inside the other and locked together. The cutting piece fits inside the guide piece and the grip piece fits over the guide piece and cutting piece. Grip piece 110 and guide piece 130 together define a shaft 120 having a mouth 122 at a distal end thereof and a flange 132 extending radially around an aperture 124 at a proximal end of the shaft.

Grip piece 110, guide piece 130 and cutting piece 150 nestled together form a cutting mechanism 140. The cutting mechanism has a retracted state and an extended state. In the retracted state, teeth of the cutting mechanism are safely stowed away and retracted into the aperture. In the extended state, the teeth protrude out of the aperture at the proximal end of the shaft.

Cutting Mechanism

The instant innovation includes a safety cutting mechanism with an innovative structure and method of actuation. Cutting piece 150 is an annular ring 152 with a fluted external surface, three teeth 154 protruding from the bottom (proximal) edge 156 of the ring and two arms or pawls 158 that extend from opposite sides of the external surface of the annular ring 152.

Guide piece 130 has a shaft portion 134 and a flange 132 extending radially around aperture 124 at a proximal end of the shaft/shaft portion. A guide path 136 is cut into the sidewall of the shaft portion of the guide piece 130. The annular ring 152 has a slightly smaller circumference than the shaft portion 134 and fits inside the shaft portion. The arms 158 extend into the guide path 136 of the shaft portion of the guide piece.

Guide path 136 is comprised of two, minor-image tracks. Each track spans almost half of the circumference of the side-wall of the shaft portion. The tracks are separated from each other a solid portion/partition 138 of the sidewall. The two solid portions are located opposite each other in the sidewall. Each track of the guide path has a structure whereby the track starts next to the solid portion at an upper level of the side-wall. The track runs for a very short distance at the upper level and then angles down towards a lower level at about a 45° angle. The track then continues at the lower level for less than half the circumference of the shaft portion sidewall before angling back up to the upper level at the same, approximately 45° angle. The path continues at the upper level for a short distance terminating at the second solid portion/partition. At the point between the upper level and the angled portion, there is a slightly raised hillock inside the track. The hillock or protrusion 142 locks the arm at the upper level, between the partition and the hillock. When the arms lock into the locking station they make an audible “click” sound indicating to the user that the cutting piece is safely stowed.

The effect of moving the cutting piece along the guide path will now be explained. When the arms 158 are locked on the upper level, the teeth of the cutting piece are retracted within the shaft 120 and not protruding out of the aperture 124 of the shaft. The tips of the teeth 154 are in line with the bottom (proximal) edge of the shaft portion sidewall 134. In this position the teeth are hidden from view and are safely stowed away to prevent damage to other objects or people.

In order to actuate the cutting mechanism, the user must move the arms through the guide path from the locking position on one end to the locking position on the other end. This happens to both arms, at opposite sides of the shaft portion sidewall and opposite ends of the guide path. All in all, the cutting piece is rotated less than 180° about a central axis (hereafter “X-axis”) of the shaft 120.

When the arms move down the angled parts of the guide path, the teeth extend out of the aperture to protrude beyond the proximal edge of the shaft portion sidewall 134. In this position the teeth are visible and are able to puncture the packaging of a pourable product. In the next stage of the rotation, the arms traverse the lower level portions of the guide path tracks. When attached/adhered to a package, the teeth make a circular incision in the surface of the packaging material while the arms are traversing the lower level portions of the tracks. At the final stage of the actuation procedure, the arms travel back up the angled portions of the tracks to the upper levels and lock in place. Traveling back up the angled portions retracts the teeth back into the safe position. The actuation procedure is now complete.

The teeth are located at three points of an imaginary triangle that has two equal-length short sides and a third side that is longer than the other two sides. Said in another way, the lengths of the portions of the circumference between two of the teeth are equal while the length of the third portion of the circumference is longer than each of the other two. Preferably, the cutting teeth 154 are made of a material that is stronger and more resilient that the rest of the dispensing system. For example, the teeth may be formed from Acetal which is stronger than polypropylene, polyethylene silicone, nylon, latex elastomers etc. which can be used to make the other components of the dispensing system.

The teeth are adapted to cut most types of packaging material made from polypropylene, polyethylene, nylon, cardboard as well as multi-layered packaging materials.

When the cutting mechanism is actuated, a circular incision is made in the packaging surface that the device is adhered to. The position of the teeth ensures that when the cutting mechanism is actuated, the circular incision made in the package is incomplete, such that a circular flap of material remains attached to the package by a small stem or tab of uncut material. The teeth are structured in a manner that ensures that the circular flap is raised towards distal mouth of the shaft and not towards the inner volume of the package. Both the fact that the flap remains attached, and the fact that the flap is raised outwards, ensures that the user is able to easily grip the flap and easily tear it the rest of the way. Thus the flap does not fall or get pushed into the package, but is rather easily removed and discarded.

Grip piece 110 is circular in shape, has an inner wall 112 and an outer wall 114 which are spaced apart. The walls are closed on the upper (distal) end 113 and open on the bottom (proximal) end (not visible in the figures). There are two protrusions 116 in the external surface of the grip piece. The protrusions are located on opposite sides of the circular grip piece. Corresponding to the external protrusions 116, there are two gaps (not shown) in the inner surface of the outer wall 114. The grip piece 110 fits over the shaft portion 134 of the guide piece 130 and the arms 158 of the cutting piece 150. The shaft portion fits into an empty channel that is defined by the inner wall, the outer wall and the closed upper end of the grip piece. The arms fit into the gaps in the inner surface of the outer wall 114, such that moving the grip piece moves the arms of the cutting piece and hence controls the cutting action of the cutting mechanism.

The protrusions 116 have more than one function. A first function, as just mentioned, is to hold the arms of the cutting piece in order to rotate the cutting piece. The second function of the protrusions is to provide a gripping element for the user, in order to rotate the grip piece and control the cutting mechanism. When the cutting mechanism is actuated by rotating the grip piece, both the grip piece and the cutting piece move while the guide piece remains stationary.

In some embodiments, the grip piece and/or lid further includes a bar attachment for users with weak hands (e.g. elderly) to assist in the twisting motion needed to form an incision in the package. Additionally or alternatively, three-dimensional figures may be formed on the upper surface of the lid 300. The 3-D figures can be for promotional purposes, e.g. a Mickey Mouse figure. The upper surface of the lid can additionally or alternatively be used for advertising purposes such as displaying a logo and the like.

Alternatively or additionally, the external surface of the lid can have a functional configuration such as a hook or ring etc. for hanging the device and attached package on a rack or the like. The lid surface may additionally or alternatively be magnetized to adhere to a metal surface.

While the depicted, exemplary embodiment of the dispensing system entails a circular form factor, it is made clear that all or some of the components of the dispensing system may be of a different shape. That is to say that the shape of the dispensing apparatus and/or attachment piece, or part/s thereof, can alternatively have a square, rectangular, pentagon, hexagon or any other polygon or closed shape. The cutting mechanism and/or the actuating mechanism is adapted for each shape, form or size.

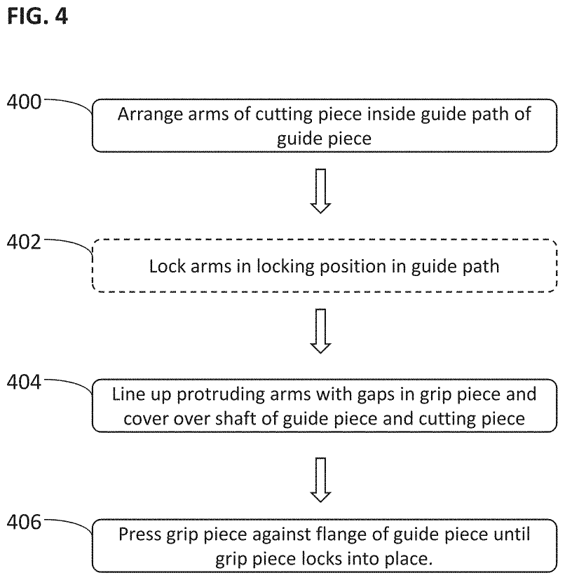

FIG. 4 is a flow diagram of a method of assembly of the dispensing piece 100. Step 400, arrange the cutting piece inside the shaft portion of the guide piece by inserting the arms 158 into the guide path 136 and nestling the ring of the cutting piece parallel to the shaft portion. The circumference of the cutting piece is smaller than the circumference of the shaft portion of the guide piece. The outer surface of the cutting piece is fluted.

Step 402, optionally but preferably, lock the arms in the upper level locking position.

Step 404, line up the internal gaps of the inner surface of the outer wall of the grip piece with the protruding arms of the cutting piece and place the grip piece over the shaft portion and cutting piece.

Step 406, press the grip piece towards the flange of the guide piece until the grip piece locks into place. When locked in place, the inner wall of the grip piece is the inner-most portion which defines the shaft/aperture 120. Moving outwards from the shaft, the next element is the sidewall/ring of the cutting piece, then the shaft portion of the guide piece and then the outer wall of the grip piece. Below the aforementioned circular pieces is the flange portion of the guide piece.

Attachment Piece

The attachment piece 200 includes a flat ring 210 that has an upper, distal surface 212 and a lower, proximal surface 214. The upper surface 212 is ringed by a low sidewall 216. Four clip-on tabs 218 are provided on sidewall 216 and located equidistantly from each other. It is made clear that locking tabs are merely one exemplary method and mechanism four coupling the dispensing apparatus to the attachment piece. Other coupling arrangements known in the art are considered within the scope of the invention as if fully set forth herein. For example, in place of tabs, the attachment piece may include pins that slot into corresponding holes in the flange in a detachable locking connection. Another example is a twist-and-lock connection arrangement whereby the attachment piece and flange further include necessary components for such a connection. Yet another example is a magnetic coupling arrangement whereby one surface includes a metal layer and the other surface includes a magnetic layer. The metal and magnetic layers are mated together in a hermetic coupling. Many other configurations are known in the art and considered to be included within the scope of the invention as if fully set forth herein.

Each tab 218 has a horizontal ledge 220 located slightly higher than the top edge of the sidewall 216. In the middle of the ledge 220 is a locking protrusion 222. Flange 132 has a rutted upper edge 133. When the smooth bottom surface of the flange 132 is mated with the upper surface 212 of the flat ring 210, the clip-on tabs lock the flange (and hence the entire dispensing apparatus) to the attachment piece. The tabs flex outwards to receive the rim of the flange and, once the flange passes the upper side of the ledge 220, return inwards to fit over the edge of the flange, locking the apparatus to the attachment piece, preventing lateral separation. The locking protrusions 222 slot into ruts in the rutted upper edge 133 of the flange, locking the dispensing apparatus and attachment piece together and preventing rotational displacement of the flange(and hence the guide piece) relative to the attachment piece.

Lower surface 214 is provided with an adhesive layer. A removable release liner 230 (which is a peel-off paper strip) is adhered to the adhesive layer. Liner 230 includes a tongue 232 for easily gripping and removing the paper strip. The release liner is typically wax paper. The attachment piece is adapted for single use. The liner is removed exposing the adhesive layer. The adhering portion/attachment piece is adhered to the packaging surface by mating the adhesive layer to a smooth surface of the packaging. Preferably, an adhesive that is FDA approved for use in conjunction with foodstuffs is used. Preferably, the adhesive does not adhere to human skin in a strong bond.

The adhesive can be applied in a silk screening process or by attaching double-sided tape double-sided tape to the proximal side of the attachment piece. The tensile strength of the adhesive layer is preferably sufficiently strong that a package of between 1-1.5 kg in weight can be lifted by the attached dispensing device when coupled to the attachment piece which is adhered to the package. Due to the preferred strength of the bond, the attachment piece is non-removable once attached. When the container of pourable material is exhausted, the packaging, together with the attachment piece, discarded. As such, the attachment piece 200 is adapted for use with a single package only and is not reusable.

By contrast, once the pourable material is exhausted from the package, the dispensing apparatus is detached from the attachment piece so as to be reused with a new attachment piece on a different package. As such, the dispensing apparatus is a re-usable or multi-use apparatus while the attachment piece is a single-use piece. Consequently, a user should purchase many attachment pieces—as they are discarded once the package is discarded—but only few dispensing apparatuses as they can be re-used many times.

Covers and Accessories

As mentioned above, the dispensing system includes a resealable lid for covering and/or stoppering the distal mouth of shaft. The resealable lid may be permanently coupled to the dispensing apparatus (e.g. integrally formed, bonded, non-detachably attached) or detachably coupled to the apparatus as a separate piece such as a screw-on cap or a bung.

In the instantly described and depicted embodiment, there is provided a resealable lid 300 which is integrally formed with grip piece 110 with a flip-top hinge 302. The lid is one of a multitude of coverings that can be used in conjunction with the grip piece. Accordingly, the depicted flip top lid is merely exemplary and not intended to be limiting in any way, shape or form.

Lid 300 has an inner, raised sidewall 304 that fits inside distal mouth 122 when the lid is closed over the grip piece. The lid further has an outer sidewall 306 and a channel 308, between the inner and outer sidewalk. The lid further includes a tab 310 for lifting the lid off the grip piece. An indentation 314 is located below the tab when in the closed position (see FIG. 1). A locking protrusion 312 interlocks with an inner rim of the grip piece to form a locking arrangement which holds and lightly locks the lid in place over the grip piece.

Various configurations, components, variations and modifications described hereafter are not intended to be limited to individual embodiments but rather can either be limited to individual embodiments or embodiments that include more than one of the configurations, components, variations or modifications that are detailed hereafter. Any description, mode or method of implementation or descriptive detail provided for one of the configurations, components, variations or modifications is intended to apply to all the other thereof, mutatis mutandis, as if fully set forth herein for each thereof.

The same is true of all of the alternative implementations, variations and modification mentioned heretofore. For example, as mentioned above, the shape of the dispensing apparatus, or part thereof, can alternatively be square, rectangular, pentagon, hexagon or any other polygon or closed shape. As such, for example, the cutting mechanism may be the same cutting mechanism or a different cutting mechanism that performs the same function in a respective manner adapted to the precise shape and/or form of the apparatus.

Referring once again to the lid 300 of the instant dispensing system, in embodiments, the cap or lid forms a water-tight seal in a closed state. Alternatively, the cap or lid forms an air-tight seal in the closed state (an air-tight seal is also a watertight seal). In embodiments, the cap or lid includes a compartment adapted to receive a desiccant bag for removing moisture for the package to which the dispensing system is attached. In embodiments, the lid and/or entire system can be made from plastic imbued with a given scent. Over time the scent wafts into the inner volume of the package. In embodiments, scented tablets or bags and the like can be housed in a compartment on the underside of the lid. In embodiments, scent extracting materials/tablets can be housed in the aforementioned compartment to extract and/or neutralize undesired scents/small from the package contents.

In embodiments, the dispensing system further includes a filter, adapted to fit in the distal mouth. The filter, e.g. a mesh, serves to allow small particles to pass out of the package and dispensing spout while keeping larger particles inside. A mesh is a barrier made of connected strands of metal, fiber, or other flexible or ductile materials. Alternatively the filter may prevent solid particles from passing there-through while allowing liquid to pass there-through. It is understood, that some such filters will allow particles of a limited size to pass there-through together with the liquid.

Alternatively or additionally, there is a portion control mechanism connected to the dispensing apparatus or disposed inside the mouth of the spout. The portion control mechanism is adapted to allow only a predefined portion of the pourable contents be dispensed at a time. Many mechanisms for predefined portion dispensation are known in the art and are considered to be included within the scope of the invention as if fully set forth herein.

In embodiments, the distal mouth is fitted with an adaptor or receptacle for receiving a vacuum hose. The adaptor or receptacle may further include a means for sealing the spout/mouth prior to removing the vacuum hose, so as to maintain the vacuum inside the package.

In embodiments, the dispensing system further includes a grinder operationally coupled to the spout, for grinding the pourable contents of the package prior to dispensing. The grinder may be a manual grinder or an automatic grinder.

The filter, portion control mechanism, vacuum hose adaptor and/or grinder may be coupled to the apparatus in a permanent manner (e.g. integrally formed with the dispensing apparatus or bonded there-with) or in a detachable manner (e.g. by screwing the accessory into a corresponding thread inside the mouth of the spout and the like).

In embodiments, the cap or lid has a counter disposed on an outer surface thereof. The counter may be integrated into the lid, bonded to the lid or removably attached to the lid. The counter may be a manually manipulated counter or an automatic counter. The counter may, for example, reflect a number of days that the package has been open or the amount of pourable material that has been dispensed from the package or that remain inside the package.

In embodiments, the cap or lid has a human interface device (HID) disposed on an outer surface thereof. The HID is adapted display output. For example, the HID may be an LCD display. In embodiments, the HID is further adapted to receive input. The HID may have buttons, a touch screen, a port for a wired connector and/or wireless connection to a separate input device keyboard, portable compute etc.).

In embodiments the cap or lid further includes at least one sensor disposed on an inner surface thereof. In embodiments, sensor/s is/are coupled to the aforementioned HID. The sensor or sensors is/are selected from the group of sensors adapted to sense at least one of: an allergen, motion, weight, decomposition, insect pheromones, color.

An allergen sensor can sense whether the package that the dispensing system is coupled to has allergenic components and what those components are. A motion sensor can detect whether there is movement inside the package. Such movement is indicative of an insect infestation (e.g. worms in rice, weevils in flour etc.) inside the package. A weight sensor provides a measurement of weight of the contents and package. A sensor capable of detecting decomposition can be used to inform the users of an expired and decomposing product inside the package. Insects communicate by releasing pheromones. Therefore a pheromone sensor can indicate the presence of insect life inside a package. An optical/color sensor can detect a change in color indicative of infestation and/or decomposition.

In embodiments, the HID is adapted to display information for the aforementioned sensors. In embodiments, the HID is adapted to send notifications and alerts to a remote computing device. Exemplarily, the HID is or has a wireless communications component that is adapted to send data to a remote computing device, the data selected from the group including: raw sensor data from the sensor/s, processed sensor data, and/or a notification or alert that is indicative of processed sensor data. Wireless communication technologies are well known in the art, such as, for example, Bluetooth, Low Energy Bluetooth, WiFi, cellular communications. Many other technologies and protocols are known in the art and considered to be within the scope of the instant invention.

FIG. 3 illustrates a profile view of the side of the dispensing system 10. The dispensing system has a covering part 12, a shaft part 14 and a flange part 16. The covering part is embodied in the instant, exemplary configuration by a hingedly coupled lid 300. The shaft part 14 of the dispensing system 10 encompasses the distal mouth 122 and the upper, distal portion of the dispensing apparatus. The flange part 16 extends radially around the aperture at the proximal end of shaft part. The flange part 16 encompasses the flanged portion of the grip piece 110 and the flange 132 of the guide piece 130. The attachment piece 300 is adapted to detachably couple to the flange part 16 of the dispensing system and specifically to the flange 132.

Method of Use

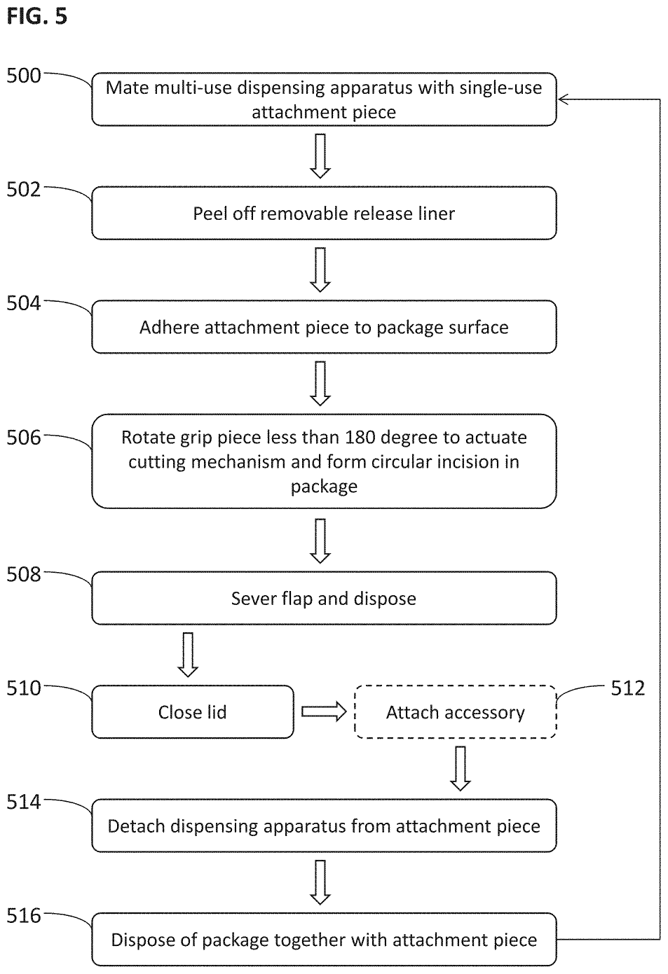

The dispensing system 10 is adapted to be used on packages that do not have an adequate dispensing arrangement. The following process is followed for providing a dispensing arrangement to a new, unopened package. FIG. 5 is a flow diagram of a process of applying the instant dispensing system to packages. Initially, the process entails providing a dispensing apparatus adapted to dispense the pourable material from the package. The dispensing apparatus is adapted for reuse with a plurality of packages. Providing an attachment piece adapted to detachably couple with the dispensing apparatus and permanently couple with the package.

Step 500, entails mating the dispensing apparatus with the attachment piece. A reusable dispensing apparatus such as dispensing apparatus 100 (assembled according to the process described above) is mated with a single-use attachment piece such as attachment piece 200 detailed above. In the mating step, as detailed above, the flexible tabs 218 flex outwards (elastically deform) to receive the rutted upper edge 133 of flange 132 and then return to their previous position, locking the dispensing apparatus to the attachment piece. The horizontal ledge 220 of each tab 218 prevents lateral separation of the, pieces 100, 200 and the, locking protrusion 222 of each tab slots into a rut on the upper edge 133 preventing rotational movement of the dispensing apparatus relative to the attachment piece.

Step 502, the removable release liner 230 is peeled away from the adhesive layer on the lower surface 214 by grasping tongue 232 and gently pulling the liner away.

Step 504, the exposed adhesive layer is attached to a flat clear surface of the packaging.

Step 506, the grip piece is twisted and rotated just short of half a revolution (less than 180° about the X-axis) by a user. The grip piece and cutting piece rotate while the attachment piece and flange (in fact the entire guide piece) remain stationary. The cutting teeth of the cutting piece form an incomplete circular incision in the package surface.

Step 508, the user reaches in through the mouth, spout and proximal aperture to grip the circular flap and detach it from the package surface. The dispensing system is now ready for use.

Step 510, closing the lid to prevent pourable material from spilling out of the package.

Optional step 512, an accessory is coupled to the dispensing apparatus for additional functionality.

Step 514, when the package is ready to be discarded, the dispensing apparatus is detached from the attachment piece. The user manually flexes the tabs away from the flange to unlock the dispensing apparatus.

Step 516, the package together with the attachment piece is discarded.

Go to Step 500, a new attachment piece is coupled to the dispensing apparatus.

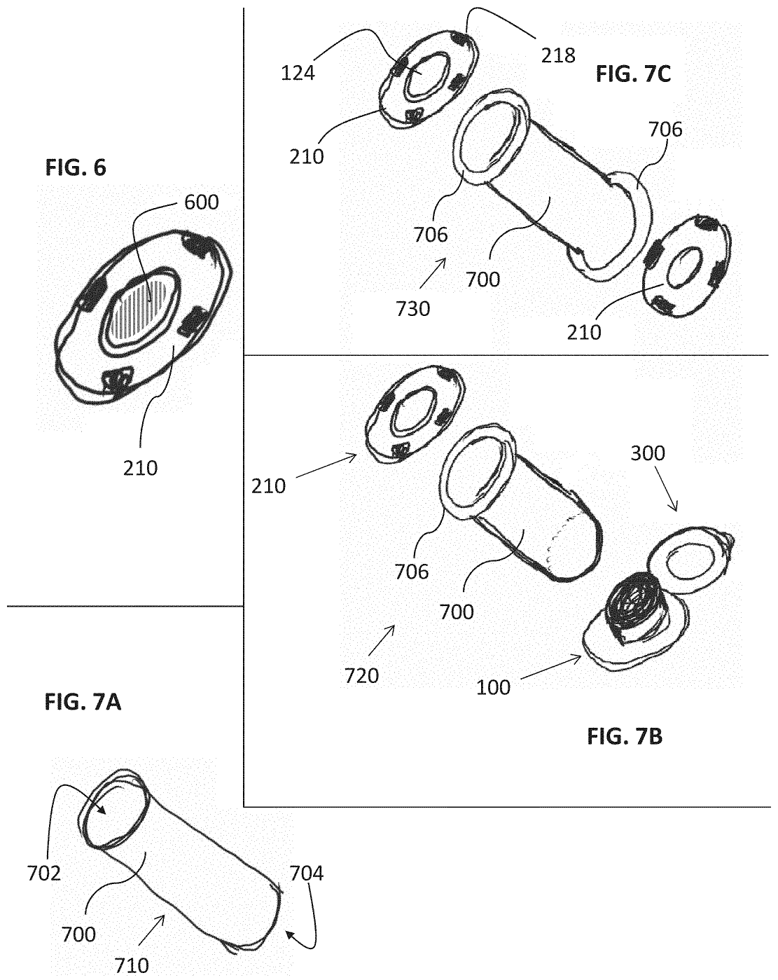

Reusable and Single-Use Stopper FIG. 6 illustrates a stopper coupled to an attachment piece of the instant system. In embodiments there is provided a stopper 600 that is used in conjunction with the attachment piece, in place of the dispensing apparatus. The stopper 600 covers over the opening/aperture formed by the cutting piece. The stopper is adapted to fit into or cover over the aperture and adapted for stoppering the aperture after detaching the dispensing apparatus.

According to one configuration, the stopper can click into the opening itself like a cork or bung. Alternatively, the stopper clicks into the tabs 218 of the attachment piece 210, covering over the aperture. Additional coupling arrangements are known in the art and can be applied to the present innovation based on the description provided herein. For example, the stopper can have a threaded edge for screwing into the aperture or a conical edge for fitting like a sink plug or a press-and-twist arrangement and more.

In preferred embodiments, the stopper 600 is a disposable disc that fits into or over the aperture 124 of the attachment piece. In order to reopen the aperture 124, the cutting mechanism is once again actuated to either to excise the stopper (in the former configuration) or make a new opening in the stopper (in the latter configuration).

In other embodiments, the stopper is a reusable stopper, e.g. a thin circular disc that clicks into the tabs 218 or aperture 124 and can thereafter be removed from the tabs or aperture. For example, the disc may have a ring on the external surface which a user can pull on to remove the disc 600 from the attachment piece. The stopper (single use or multi-use be adapted for a variety of functions, such as, but not limited to: a temporary closure, transparent disc providing a window into the package, a content-monitoring disc with a sensor (such as described above).

For example, a user can open a cardboard or plastic packaging using the dispensing system described above and then click the disc in/onto the ring; the internal surface of the disc has a sensor for monitoring the packaging for gases, movement, etc. (as described above).

Connector

In some instances, it will be preferred to reuse a given container (which is fitted with a dispensing system of the instant innovation) by refilling the contents from time to time. To that end, there is provided a connector 710, 720, 730. The connector consists of a tube 700 with a first opening 702 on one end of the tube and a second opening 704 on a second end, opposite the first end.

FIG. 7A illustrates a first configuration of a connector 710. Connector 710 is adapted to couple two dispensing apparatuses in fluid communication. The tube 700 connects to the distal mouth of one dispensing apparatus on the first end by placing first opening 702 over or inside the distal mouth. The second opening 704 of the tube 700 is placed over or inside the distal mouth of a second dispensing apparatus. The dispensing apparatuses and packages which they are mounted on are now in fluid communication, allowing a user to pour contents from one package to the other without spillage.

FIG. 7B illustrates a second configuration of a connector 720. Connector 720 is adapted to connect an attachment piece to a dispensing apparatus. Connector 720 includes a flange 706 on the first end. The flange interlocks with the attachment piece on the first end. On the second end, opening 704 fits over or in the mouth of dispensing apparatus 100, depending on whether the circumference of the tube 700/opening 704 is bigger or smaller than the circumference of the distal mouth 122 of the dispensing apparatus 100.

FIG. 7C illustrates a third configuration of a connector 730. The connector is adapted to couple two attachment pieces 210 mounted on respective packages and place the packages in fluid communication with each other. Connector 730 has flanges 706 over both ends of the tube 700.

In another embodiment, the connector may have a conical structure instead of a tubular structure. The connector that has a conical structure functions as a funnel for filling or refilling the package with pourable material. The narrow end of the conical connector couples with a dispensing apparatus or an attachment piece as described heretofore). A user pours material into the package via the connector. The wide end of the conical connector minimizes spillage as would be readily understood by one skilled in the art.

While the invention has been described with respect a limited number of embodiments, it will be appreciated that many variations, modifications and other applications of the invention may be made. Therefore, the claimed invention as recited in the claims that follow is not limited to the embodiments described herein.

What is claimed is:

1. A dispensing system for a package of pourable contents, the system comprising:
a dispensing apparatus including:
(a) a shaft part having a mouth at a distal end thereof;
(b) a flange part extending radially around an aperture at a proximal end of said shaft part; and
(c) a cutting mechanism nestled in said shaft part, said cutting mechanism having a retracted state and an extended state;
wherein said dispensing apparatus is adapted for use with one or more packages.

2. The system of claim 1, further comprising:
an attachment piece adapted to detachably couple to said flange part, said attachment piece having a proximal surface provided with an adhesive layer;
wherein said attachment piece is adapted for use with a single package.

3. The system of claim 2, wherein the pourable contents are dispensable from the package in a controlled manner after forming an incision in a surface of the package under said aperture.

4. The system of claim 1, wherein in said retracted state, teeth of a cutting piece of said cutting mechanism are retraced into said aperture and in said extended state, said teeth protrude out of said aperture at said proximal end of said shaft part.

5. The system of claim 1, wherein said cutting mechanism includes:
(i) a cutting piece comprising an annular ring, teeth protruding from a proximal edge of said ring and two arms that extend from opposite sides of an external surface of said ring;
(ii) a guide-path for said arms, said guide-path structured to guide said cutting piece to protrude beyond, and retract back from, a bottom edge of said proximal aperture of said shaft part; and
(iii) a grip piece for actuating said cutting mechanism by rotating said cutting piece about a central axis of said shaft part and moving said arms along said guide path.

6. The system of claim 5, wherein said guide-path allows for rotation of said cutting piece more than 90° and less than 180° about said central axis.

7. The system of claim 5, wherein said cutting piece is adapted to cut an incomplete circular incision in the package in such a manner that a circular flap of material of the package remains attached to the package.

8. The system of claim 7, wherein said circular flap of material is raised towards said distal mouth.

9. The system of claim 2, further comprising a lid operationally coupled to said dispensing apparatus and adapted to close said mouth on said distal end.

10. The system of claim 9, wherein said lid forms a water-tight or airtight seal with said dispensing apparatus in a closed state.

11. The system of claim 2, further comprising a stopper adapted to fit into or cover over said aperture, said stopper adapter for stoppering said aperture after detaching said dispensing apparatus.

12. The system of claim 9, wherein said lid includes a compartment adapted to receive a desiccant bag or scented bag.

13. The system of claim 9, further comprising:
a filter, adapted to fit in said distal mouth.

14. The system of claim 9, further comprising:
a portion control mechanism adapted to allow a predefined portion of the pourable contents to be dispensed.

15. The system of claim 9, wherein said distal mouth is fitted with an adaptor for receiving a vacuum hose.

16. The system of claim 15, further comprising a means for sealing said distal mouth prior to removing said vacuum hose.

16. The system of claim 9, further comprising a manual or automatic grinder operationally coupled to said dispensing apparatus, for grinding said pourable contents prior to dispensing.

17. The system of claim 9, wherein said lid has a counter disposed on an outer surface thereof.

18. The system of claim 9, wherein said lid has a human interface device (HID) disposed on an outer surface thereof, said HID adapted display output.

19. The system of claim 18, wherein said HID is further adapted to receive input.

20. The system of claim 18, wherein said HID is further adapted to send notifications and alerts to a remote computing device.

21. The system of claim 9, wherein said lid further includes at least one sensor disposed on an inner surface thereof, said at least one sensor is selected from the group of sensors adapted to sensor at least one of: an allergen, motion, weight, decomposition, insect pheromones, color.

22. The system of claim 1 wherein said dispensing apparatus is adapted to be twisted and rotated by a user.

23. The system of claim 1, wherein said dispensing apparatus further includes a bar attachment for weak hands.

24. The system of claim 2, further comprising a connector with a first opening, a second opening and a body there-between, said connector adapted to couple to said distal mouth or said attachment piece at said first opening.

25. A dispensing system comprising:
an attachment piece adapted to detachably couple to a dispensing apparatus, said attachment piece having a proximal surface provided with an adhesive layer;
wherein said attachment piece is adapted for use with a single package.

26. The dispensing system of claim 25, further comprising said dispensing apparatus including:
(a) a shaft part having a mouth at a distal end thereof;
(b) a flange part extending radially around an aperture at a proximal end of said shaft part; and
(c) a cutting mechanism nestled in said shaft part, said cutting mechanism having a retracted state and an extended state;
wherein said dispensing apparatus is adapted for use with one or more packages.

27. A method of dispensing a pourable material from a package, the method comprising:
(a) providing a dispensing apparatus, said dispensing apparatus adapted to dispense the pourable material from the package, said dispensing apparatus adapted for reuse with a plurality of packages;
(b) providing an attachment piece adapted to detachably couple with said dispensing apparatus and permanently couple with the package;
(c) mating said dispensing apparatus with said attachment piece;
(d) adhering said attachment piece to a flat surface of the package so as to form an adhesive bond between said attachment piece and the package;
(e) actuating a cutting mechanism of said dispensing apparatus to form an incomplete circular incision;
(f) remove a circular flap of packaging material formed by said incomplete circular incision;
(g) uncoupled said dispensing apparatus from said attachment piece; and
(h) discard said package with said attachment piece adhered thereto.

28. The method of claim 27, further comprising:
peeling off, prior to step (d), a removable release liner from a lower surface of said attachment piece to expose an adhesive layer on said lower surface.

29. The method of claim 27, further comprising:
attaching an accessory or connector to said dispensing apparatus.
